(19) United States
(12) Patent Application Publication
(10) Pub. No.: US 2026/0236054 A1
(43) Pub. Date: Aug. 13, 2026

(54) BANDGAP REFERENCE CIRCUIT WITH STARTUP CIRCUIT FOR ULTRA-LOW POWER CONSUMPTION UNDER HIGH-TEMPERATURE CONDITIONS

(71) Applicant: Guangdong University of Technology, Guangzhou, (CN)

(72) Inventors: Zhihao Zhang, Guangzhou (CN); Junjie Zhou, Guangzhou (CN); Hongtian Deng, Guangzhou (CN); Shihui Ke, Guangzhou (CN); Guohao Zhang, Guangzhou (CN)

(21) Appl. No.: 19/530,768

(22) Filed: Feb. 5, 2026

(30) Foreign Application Priority Data
Feb. 11, 2025 (CN) 202510150696.4

(51) Int. Cl. G05F 3/26

(52) U.S. Cl. CPC G05F 3/262

(57) ABSTRACT

A bandgap reference circuit with a startup circuit for ultra-low power consumption under high-temperature conditions is provided, including: a control circuit module, a startup core circuit unit, a leakage compensation circuit unit, and a bandgap reference circuit module; the control circuit module is configured to establish a startup identification signal; the startup core circuit unit is configured to provide a startup temporary current to the bandgap reference circuit module, the bandgap reference circuit module escapes a degenerate electrical state of zero current; the leakage compensation circuit unit is configured to generate a corresponding mirrored leakage current when the startup core circuit unit has a leakage, thereby maintaining the balanced state of the bandgap reference circuit module; and the bandgap reference circuit module is configured to generate and output a reference voltage.

### CROSS-REFERENCE TO RELATED APPLICATIONS

This application claims priority to Chinese Patent Application No. 202510150696.4, filed on Feb. 11, 2025, the contents of which are hereby incorporated by reference.

### TECHNICAL FIELD

The present disclosure relates to the field of integrated circuit technology, and in particular to a bandgap reference circuit with a startup circuit for ultra-low power consumption under high-temperature conditions.

### BACKGROUND

A bandgap reference source is an internal reference voltage source of a chip that may generate a stable voltage independent of temperature changes and voltage fluctuations. It is widely used in circuits such as analog-to-digital converters (ADC), digital analog converters (DAC), and low dropout linear regulators (LDO) to provide a reference voltage for comparison, thereby ensuring the high precision and stability of the overall circuit. In recent years, with the rise of wearable electronic devices, there has been an increasing demand for low static power consumption of electronic systems. As a core component of electronic systems, bandgap references are also expected to have the lowest possible power consumption while ensuring stability, so as to extend the battery life of devices.

In a bandgap reference circuit, the circuit usually has two operating states: the first is a normal operating state, and the second is a state where there is no current in the circuit at all. For the second case, a startup circuit needs to be added to help the circuit escape the abnormal operating state. The most common startup circuit helps the circuit escape the no-current operating state when the circuit is just started, and after the circuit has current and operates normally, the startup circuit is usually turned off to reduce the power consumption of the circuit. In the prior art, the startup circuit usually forms a current sink through a metal-oxide-semiconductor (MOS) transistor and is connected to the output terminal of the bandgap reference operational amplifier. The output terminal of the operational amplifier is pulled down to start the circuit and inject a temporary current. After the operational amplifier is started, the transistor is turned off. Ideally, the transistor will not affect the core circuit of the bandgap reference after being turned off, and the output voltage of the bandgap reference operational amplifier is determined by the core circuit of the bandgap itself. However, in reality, MOS transistors may have picoampere-level leakage current at high temperatures. Such a leakage current has almost no impact on the performance of circuits with microampere-level and above power consumption at high temperatures, but for circuits with nanoampere-level power consumption, it may cause serious mismatch of the operational amplifier, reduction of gain, and other conditions, thereby affecting the output voltage or current of the bandgap reference, and further affecting the precision and stability of the bandgap reference source.

Therefore, there is an urgent need to design a startup circuit that may ensure the normal startup of the ultra-low power bandgap reference under high-temperature conditions and maintain the performance of the bandgap reference, so as to meet the operating requirements of the bandgap reference circuit.

### SUMMARY

The present disclosure provides a bandgap reference circuit with a startup circuit for ultra-low power consumption under high-temperature conditions, configured to solve the technical problem that the startup circuit designed based on the existing bandgap reference circuit is difficult to ensure the normal startup of the ultra-low power bandgap reference under high-temperature conditions and maintain the good operating performance of the bandgap reference.

The present disclosure provides a bandgap reference circuit with a startup circuit for ultra-low power consumption under high-temperature conditions, including: a control circuit module, a startup circuit module, and a bandgap reference circuit module; where the startup circuit module includes a startup core circuit unit and a leakage compensation circuit unit;

the control circuit module is connected to the startup circuit module, and is configured to establish a startup identification signal of the startup core circuit unit based on an enable signal and send the startup identification signal to the startup core circuit unit;

the startup core circuit unit is connected to the bandgap reference circuit module, and is configured to provide a startup temporary current to the bandgap reference circuit module according to the startup identification signal, making the bandgap reference circuit module escapes a degenerate electrical state of zero current;

the leakage compensation circuit unit is respectively connected to the startup circuit module and the bandgap reference circuit module and is configured to generate a corresponding mirrored leakage current when the startup core circuit unit has a leakage, for maintaining the balanced state of the bandgap reference circuit module; and

the bandgap reference circuit module is configured to generate and output a reference voltage based on an input power supply and the startup identification signal.

In an embodiment, the startup core circuit unit includes a positive channel metal oxide semiconductor (PMOS) transistor Mp2, a negative metal oxide semiconductor (NMOS) transistor Mn1, and an NMOS transistor Mn2;

a grid of the PMOS transistor Mp2 is respectively connected to a grid of the NMOS transistor Mn1 and a first terminal of the bandgap reference circuit module, a drain of the PMOS transistor Mp2 is connected to a first terminal of the control circuit module, and a source of the PMOS transistor Mp2 is respectively connected to a second terminal of the control circuit module, a drain of the NMOS transistor Mn1, and a grid of the NMOS transistor Mn2;

a grid of the NMOS transistor Mn1 is connected to the first terminal of the bandgap reference circuit module, a drain of the NMOS transistor Mn1 is respectively connected to the grid of the NMOS transistor Mn2 and the second terminal of the control circuit module, and a source of the NMOS transistor Mn1 is grounded;

a grid of the NMOS transistor Mn2 is respectively connected to the second terminal of the control circuit module and a first terminal of the leakage compensation circuit unit, a drain of the NMOS transistor Mn2 is connected to a second terminal of the bandgap reference circuit module, and a source of the NMOS transistor Mn2 is grounded.

In an embodiment, the leakage compensation circuit unit includes an NMOS transistor Mn3 and a resistor Res2;

a drain of the NMOS transistor Mn3 is connected to a terminal of the resistor Res2, and a source of the NMOS transistor Mn3 is grounded; and

another terminal of the resistor Res2 is connected to a third terminal of the bandgap reference circuit module.

In an embodiment, a first terminal of the leakage compensation circuit unit is specifically a grid of the NMOS transistor Mn3.

In an embodiment, the control circuit module includes an inverter INV1, an inverter INV2, a PMOS transistor Mp1, and an NMOS transistor Mn4;

an input terminal of the inverter INV1 is connected to the enable signal, and an output terminal of the inverter INV1 is connected to an input terminal of the inverter INV2;

a grid of the PMOS transistor Mp1 is connected to the output terminal of the inverter INV1, and a drain of the PMOS transistor Mp1 is connected to the input power supply; and

a grid of the NMOS transistor Mn4 is connected to the output terminal of the inverter INV2, and a source of the NMOS transistor Mn4 is grounded.

In an embodiment, the first terminal of the control circuit module is specifically a source of the PMOS transistor Mp1, and the second terminal of the control circuit module is specifically a drain of the NMOS transistor Mn4.

In an embodiment, the bandgap reference circuit module includes a PMOS transistor Mp3, a PMOS transistor Mp4, a PMOS transistor Mp5, a PMOS transistor Mp6, a resistor Res1, a bipolar transistor Bipolar1, a bipolar transistor Bipolar2, and an amplifier AMP;

a grid of the PMOS transistor Mp3 is respectively connected to a grid of the PMOS transistor Mp4 and a first output terminal of the amplifier AMP, a drain of the PMOS transistor Mp3 is connected to the input power supply, and a source of the PMOS transistor Mp3 is connected to a drain of the PMOS transistor Mp5;

a grid of the PMOS transistor Mp4 is connected to the first output terminal of the amplifier AMP, a drain of the PMOS transistor Mp4 is connected to the input power supply, and a source of the PMOS transistor Mp4 is connected to a drain of the PMOS transistor Mp6;

a grid of the PMOS transistor Mp5 is connected to a grid of the PMOS transistor Mp6, and a source of the PMOS transistor Mp5 is respectively connected to a non-inverting input terminal of the amplifier AMP and one terminal of the resistor Res1;

a source of the PMOS transistor Mp6 is respectively connected to an inverting input terminal of the amplifier AMP, a base of the bipolar transistor Bipolar2, and a collector of the bipolar transistor Bipolar2;

an terminal of the resistor Res1 is connected to the non-inverting input terminal of the amplifier AMP, and another terminal of the resistor Res1 is respectively connected to a base of the bipolar transistor Bipolar1 and a collector of the bipolar transistor Bipolar1;

an emitter of the bipolar transistor Bipolar1 is grounded; and

the base of the bipolar transistor Bipolar2 is respectively connected to the collector thereof and the inverting input terminal of the amplifier AMP, and an emitter of the bipolar transistor Bipolar2 is grounded.

In an embodiment, the first terminal of the bandgap reference circuit module is specifically the inverting input terminal of the amplifier AMP, the second terminal of the bandgap reference circuit module is specifically the first output terminal of the amplifier AMP, and the third terminal of the bandgap reference circuit module is specifically a second output terminal of the amplifier AMP.

In an embodiment, the amplifier AMP includes an NMOS transistor Man1, an NMOS transistor Man2, an NMOS transistor Man3, an NMOS transistor Man4, an NMOS transistor Man5, an NMOS transistor Man6, an NMOS transistor Man7, a PMOS transistor Map1, a PMOS transistor Map2, a PMOS transistor Map3, a PMOS transistor Map4, and a PMOS transistor Map5;

where, the NMOS transistor Man1 and the NMOS transistor Man2 form an input pair transistor of the amplifier AMP, the PMOS transistor Map1 and the PMOS transistor Map2 form a current mirror load of the amplifier AMP, and the NMOS transistor Man4 and the PMOS transistor Map5 form a current mirror load mirrored current branch of the amplifier AMP.

In an embodiment, the first output terminal of the amplifier AMP is specifically an output terminal of the current mirror load mirrored current branch; the second output terminal of the amplifier AMP is specifically an output terminal of the current mirror load.

From the above technical schemes, the present disclosure has the following advantages.

The present disclosure provides a bandgap reference circuit with a startup circuit for ultra-low power consumption under high-temperature conditions, including: a control circuit module, a startup circuit module, and a bandgap reference circuit module; where the startup circuit module is composed of a startup core circuit unit and a leakage compensation circuit unit.

The control circuit module is connected to the startup circuit module and is configured to establish a startup identification signal of the startup core circuit unit based on an enable signal and send the startup identification signal to the startup core circuit unit; the startup core circuit unit is connected to the bandgap reference circuit module and is configured to provide a startup temporary current to the bandgap reference circuit module according to the startup identification signal, so that the bandgap reference circuit module escapes a degenerate electrical state of zero current; the leakage compensation circuit unit is respectively connected to the startup circuit module and the bandgap reference circuit module and is configured to generate a corresponding mirrored leakage current when the startup core circuit unit has a leakage, thereby maintaining the balanced state of the bandgap reference circuit module; and the bandgap reference circuit module is configured to generate and output a reference voltage based on an input power supply and the startup identification signal.

In the present disclosure, the startup core circuit unit provides a temporary current for the bandgap reference circuit to avoid the bandgap reference circuit from falling into a deadlock state. At the same time, when the startup core circuit unit has a leakage, the leakage compensation circuit unit provides a mirrored leakage current to the bandgap reference circuit module, making the two output branches of the reference bandgap circuit module leak the same current simultaneously, thereby enabling the reference bandgap circuit module to maintain in a balanced operating state. Thus, the ultra-low power bandgap reference may start up normally at high temperatures while maintaining good operating performance, thereby solving the technical problem that the startup circuit designed based on the existing bandgap reference circuit struggle to ensure the normal startup of the ultra-low power bandgap reference under high-temperature conditions and maintain the good operating performance of the bandgap reference.

### BRIEF DESCRIPTION OF THE DRAWINGS

In order to more clearly illustrate the embodiments of the present disclosure or the technical schemes in the prior art, the following will briefly introduce the drawings that need to be used in the description of the embodiments or the prior art. Apparently, the drawings in the following description are only some embodiments of the present disclosure. For those of ordinary skill in the art, other drawings may be obtained according to these drawings without creative labor.

FIG. 1 is a schematic diagram of module connections of a bandgap reference circuit with a startup circuit for ultra-low power consumption under high-temperature conditions provided by the present disclosure.

FIG. 2 is a schematic diagram of specific circuit connections of a bandgap reference circuit with a startup circuit for ultra-low power consumption under high-temperature conditions provided by the present disclosure.

FIG. 3 is a diagram of a startup circuit and an ultra-low power bandgap reference circuit without considering metal oxide semiconductor (MOS) transistor leakage provided by the present disclosure.

FIG. 4 is a circuit diagram of an amplifier AMP of the bandgap reference circuit module provided by the present disclosure.

### DETAILED DESCRIPTION OFTHE EMBODIMENTS

The embodiment of the present disclosure provides a bandgap reference circuit with a startup circuit for ultra-low power consumption under high-temperature conditions, configured to solve the technical problem that the startup circuit designed based on the existing bandgap reference circuit is difficult to ensure the normal startup of the ultra-low power bandgap reference under high-temperature conditions and maintain the good operating performance of the bandgap reference.

In order to make the objectives, features, and advantages of the present disclosure more apparent and understandable, the technical schemes in the embodiments of the present disclosure will be clearly and completely described below with reference to the drawings in the embodiments of the present disclosure. Obviously, the embodiments described below are only a part of the embodiments of the present disclosure, not all of them. Based on the embodiments in the present disclosure, all other embodiments obtained by those of ordinary skill in the art without creative labor belong to the protection scope of the present disclosure.

In the description of the present disclosure, it should be noted that the terms “center”, “upper”, “lower”, “left”, “right”, “vertical”, “horizontal”, “inner”, “outer”, etc. indicate the orientation or positional relationship based on the orientation or positional relationship shown in the drawings, which is only for the convenience of describing the present disclosure and simplifying the description, and does not indicate or imply that the device or element referred to must have a specific orientation, be constructed and operated in a specific orientation, and thus may not be understood as a limitation of the present disclosure. In addition, the terms “first”, “second”, and “third” are only used for descriptive purposes and may not be understood as indicating or implying relative importance.

Unless otherwise clearly specified and limited, the terms “installed”, “connected”, and “linked” should be understood in a broad sense. For example, they may be fixedly connected, detachably connected, or integrally connected; they may be mechanically connected or electrically connected; they may be directly connected or indirectly connected through an intermediate medium, or they may be the internal communication of two elements. For those of ordinary skill in the art, the specific meanings of the above terms in the present disclosure may be understood according to specific situations.

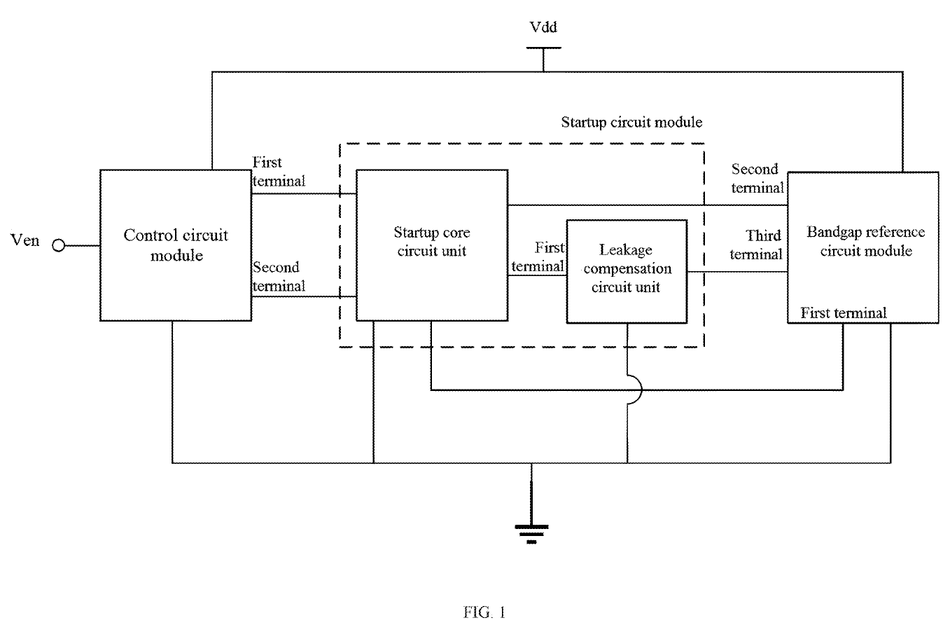

Referring to FIGS. 1, 2, 3 and 4, an embodiment of a bandgap reference circuit with a startup circuit for ultra-low power consumption suitable for high-temperature conditions provided by the present disclosure includes: a control circuit module, a startup circuit module, and a bandgap reference circuit module; where the startup circuit module includes a startup core circuit unit and a leakage compensation circuit (leakage elimination circuit) unit;

the control circuit module is connected to the startup circuit module, and is configured to establish a startup identification signal of the startup core circuit unit based on an enable signal and send the startup identification signal to the startup core circuit unit;

the startup core circuit unit is connected to the bandgap reference circuit module, and is configured to provide a startup temporary current to the bandgap reference circuit module according to the startup identification signal, making the bandgap reference circuit module escape a degenerate electrical state of zero current;

the leakage compensation circuit unit is respectively connected to the startup circuit module and the bandgap reference circuit module, and is configured to generate a corresponding mirrored leakage current when the startup core circuit unit has a leakage, thereby maintaining the balanced state of the bandgap reference circuit module;

the bandgap reference circuit module is configured to generate and output a reference voltage based on an input power supply voltage Vdd and the startup identification signal.

Specifically, when the enable signal Ven is low, the startup identification signal is a non-startup signal, and the startup core circuit unit does not provide a startup temporary current to the bandgap reference circuit module. At this time, the bandgap reference circuit module is in a non-operating state; when the enable signal is high, the startup identification signal is a startup signal, and the startup core circuit unit provides a startup temporary current to the bandgap reference circuit module, so that the bandgap reference circuit module escapes the degenerate electrical state of zero current. At this time, the bandgap reference circuit module is in an operating state, thereby outputting a reference voltage;

when the bandgap reference circuit module is operating, the startup core circuit unit draws a small amount of current from the bandgap reference circuit module to form a leakage current. Under high-temperature conditions, this leakage current may seriously affect the performance of the bandgap reference; the present disclosure sets a leakage compensation circuit unit between the startup core circuit unit and the bandgap reference circuit module to generate a corresponding mirrored leakage current, so that the bandgap reference circuit module may maintain in a balanced state without causing imbalance in its operation, thereby ensuring that the bandgap reference circuit module remains in a good operating state and guarantees the operating performance of the bandgap reference circuit module under high-temperature conditions.

Please refer to FIGS. 1, 2 and 4. The specific circuit structure of the bandgap reference circuit with the startup circuit for ultra-low power consumption under the high-temperature conditions provided by the present disclosure will be further described below.

The control circuit module includes an inverter INV1, an inverter INV2, a positive channel metal oxide semiconductor (PMOS) transistor Mp1, and an negative metal oxide semiconductor (NMOS) transistor Mn4; where an input terminal of the inverter INV1 is connected to the enable signal, and an output terminal of the inverter INV1 is connected to an input terminal of the inverter INV2; a grid of the PMOS transistor Mp1 is connected to the output terminal of the inverter INV1, and a drain of the PMOS transistor Mp1 is connected to the input power supply (Vdd); and a grid of the NMOS transistor Mn4 is connected to the output terminal of the inverter INV2, and a source of the NMOS transistor Mn4 is grounded. The first terminal of the control circuit module is specifically the source of the PMOS transistor Mp1, and the second terminal of the control circuit module is specifically the drain of the NMOS transistor Mn4.

It may be understood that when the enable signal Ven is low, the output signal Ven_B of the inverter INV1 is high, and the output signal Ven_S of the inverter INV2 is low, thereby establishing a startup signal; on the contrary, when the enable signal Ven is high, the output signal Ven_B of the inverter INV1 is low, and the output signal Ven_S of the inverter INV2 is high, thereby establishing a non-startup signal. Finally, the control circuit module transmits the startup identification signal to the startup core circuit unit through Mp1 and Mn4 according to the enable signal.

In an embodiment, the startup core circuit unit includes a PMOS transistor Mp2, an NMOS transistor Mn1, and an NMOS transistor Mn2; a grid of the PMOS transistor Mp2 is respectively connected to a grid of the NMOS transistor Mn1 and a first terminal of the bandgap reference circuit module, a drain of the PMOS transistor Mp2 is connected to a first terminal of the control circuit module, and a source of the PMOS transistor Mp2 is respectively connected to a second terminal of the control circuit module, a drain of the NMOS transistor Mn1, and a grid of the NMOS transistor Mn2; a grid of the NMOS transistor Mn1 is connected to the first terminal of the bandgap reference circuit module, a drain of the NMOS transistor Mn1 is respectively connected to the grid of the NMOS transistor Mn2 and the second terminal of the control circuit module, and a source of the NMOS transistor Mn1 is grounded; a grid of the NMOS transistor Mn2 is respectively connected to the second terminal of the control circuit module and a first terminal of the leakage compensation circuit unit, a drain of the NMOS transistor Mn2 is connected to a second terminal of the bandgap reference circuit module, and a source of the NMOS transistor Mn2 is grounded.

The startup core circuit unit adjusts the operating state of the transistors in the startup core circuit unit according to the startup identification signal output by the first terminal and the second terminal of the control circuit module; where all transistors in the startup core circuit unit are in a closed state, when the startup identification signal is a non-startup signal; and the transistor Mn2 in the startup core circuit unit is turned on, when the startup identification signal is a startup signal, thereby providing a temporary current to the second terminal of the bandgap reference circuit module, so that the bandgap reference circuit module escapes the degenerate point of zero current.

In an embodiment, the bandgap reference circuit module includes a PMOS transistor Mp3, a PMOS transistor Mp4, a PMOS transistor Mp5, a PMOS transistor Mp6, a resistor Res1, a bipolar transistor Bipolar1, a bipolar transistor Bipolar2, and an amplifier AMP;

where a grid of the PMOS transistor Mp3 is respectively connected to a grid of the PMOS transistor Mp4 and a first output terminal of the amplifier AMP, a drain of the PMOS transistor Mp3 is connected to the input power supply Vdd, and a source of the PMOS transistor Mp3 is connected to a drain of the PMOS transistor Mp5; a grid of the PMOS transistor Mp4 is connected to the first output terminal of the amplifier AMP, a drain of the PMOS transistor Mp4 is connected to the input power supply Vdd, and a source of the PMOS transistor Mp4 is connected to a drain of the PMOS transistor Mp6; a grid of the PMOS transistor Mp5 is connected to a grid of the PMOS transistor Mp6, and a source of the PMOS transistor Mp5 is respectively connected to a non-inverting input terminal of the amplifier AMP and one terminal of the resistor Res1; a source of the PMOS transistor Mp6 is respectively connected to an inverting input terminal of the amplifier AMP, a base and a collector of the bipolar transistor Bipolar2; an terminal of the resistor Res1 is connected to the non-inverting input terminal of the amplifier AMP, and another terminal of the resistor Res1 is respectively connected to a base and a collector of the bipolar transistor Bipolar1; an emitter of the bipolar transistor Bipolar1 is grounded; and the base of the bipolar transistor Bipolar2 is respectively connected to its collector and the inverting input terminal of the amplifier AMP, and an emitter of the bipolar transistor Bipolar2 is grounded.

The first terminal of the bandgap reference circuit module is specifically the inverting input terminal of the amplifier AMP, the second terminal of the bandgap reference circuit module is specifically the first output terminal of the amplifier AMP, and the third terminal of the bandgap reference circuit module is specifically the second output terminal of the amplifier AMP.

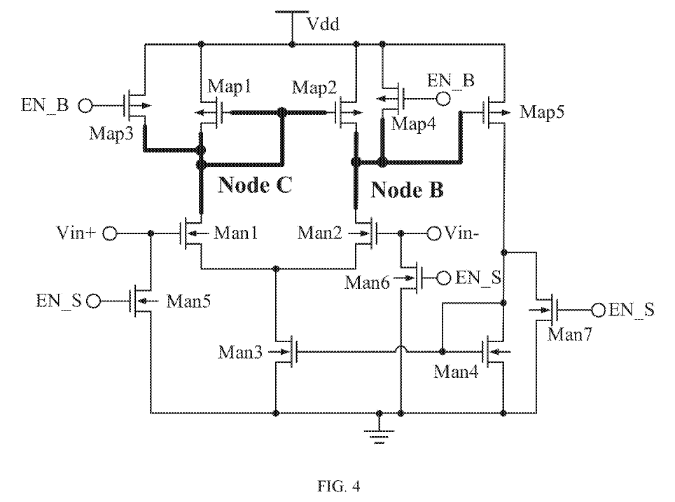

Please refer to FIG. 4. The amplifier AMP includes an NMOS transistor Man1, an NMOS transistor Man2, an NMOS transistor Man3, an NMOS transistor Man4, an NMOS transistor Man5, an NMOS transistor Man6, an NMOS transistor Man7, a PMOS transistor Map1, a PMOS transistor Map2, a PMOS transistor Map3, a PMOS transistor Map4, and a PMOS transistor Map5; where, the NMOS transistor Man1 and the NMOS transistor Man2 form an input pair transistor of the amplifier AMP, the PMOS transistor Map1 and the PMOS transistor Map2 form a current mirror load of the amplifier AMP, and the NMOS transistor Man4 and the PMOS transistor Map5 form a current mirror load mirrored current branch of the amplifier AMP. The first output terminal of the amplifier AMP is specifically an output terminal of the current mirror load mirrored current branch (i.e., node B); the second output terminal of the amplifier AMP is specifically an output terminal of the current mirror load (i.e., node C). In FIG. 4, Vin+ represents an input signal of the non-inverting input terminal of the amplifier AMP, and Vin- represents an input signal of the inverting input terminal of the amplifier AMP.

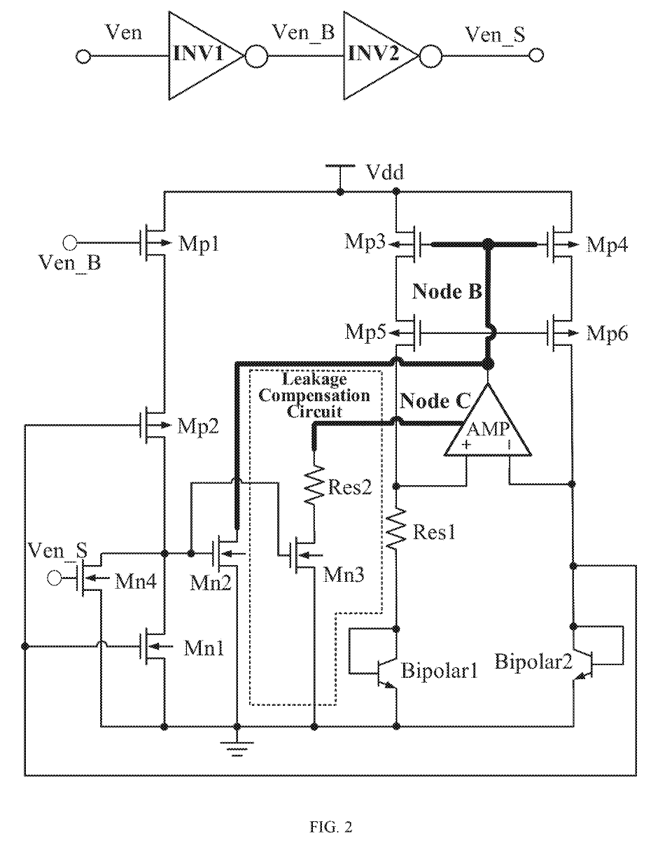

Please refer to FIGS. 2 and 4. The more specific working principle of the startup core circuit module is as follows.

(1) When the enable signal Ven is low, the output signal Ven_B of the inverter INV1 is high, and the output signal Ven_S of the inverter INV2 is low. At this time, the grid voltage of the PMOS transistor Mp1 is high, the PMOS transistor Mp1 is in a closed state, that is, no current flows through the branch where the PMOS transistor Mp1 is located, and the PMOS transistor Mp2 is in a closed state; the grid voltage of the NMOS transistor Mn4 is high, the NMOS transistor Mn4 is in an on state, but it pulls down the grid voltages of the NMOS transistor Mn2 and the NMOS transistor Mn3, and at this time, the transistors Mn2 and Mn3 are both in a closed state.

At the same time, when the enable signal Ven is low, in the amplifier AMP of the bandgap reference circuit module, the first voltage signal EN_B is low, and the second voltage signal EN_S is high. Then, the grid voltages of the NMOS transistor Man5, the NMOS transistor Man6, and the NMOS transistor Man7 are all high, and the grid voltages of the PMOS transistor Map3 and the PMOS transistor Map4 are low. At this time, the switching transistors Map3, Map4, Man5, Man6, and Man7 in the amplifier AMP are all in an on state. The entire amplifier AMP is not working at this time, and the output voltage of the first output terminal (i.e., node B) of the amplifier AMP is pulled to the input power supply voltage Vdd by the switching transistor Map4. Therefore, the entire bandgap reference circuit module is in a non-operating state.

(2) When the enable signal Ven is high, the output signal Ven_B of the inverter INV1 is low, and the output signal Ven_S of the inverter INV2 is high. At this time, except for the PMOS transistor Mp2, the other switching transistors of the startup core circuit module are in a closed state.

When the enable signal first goes high, the PMOS transistor Mp2 is turned on. When the bandgap reference circuit module is in an abnormal operating state at this time, that is, the bandgap reference circuit is locked in a degenerate point state of zero current, the current of the bandgap reference circuit module is 0, the bipolar transistor Bipolar2 is not turned on, and the grid voltages of the PMOS transistor Mp2 and the NMOS transistor Mn1 are detected as low. Then, the PMOS transistor Mp2 pulls up its drain-source voltage (which is also the grid voltage of the NMOS transistor Mn2, i.e., the voltage of node A). Therefore, the NMOS transistor Mn2 is turned on. After the NMOS transistor Mn2 is turned on, it pulls down its drain-source voltage (which is also the grid voltages of the PMOS transistor MP3 and the PMOS transistor MP4). Therefore, the PMOS transistors Mp3 and Mp4 are turned on, and the bandgap reference circuit module starts to have a temporary current, thereby escaping the degenerate point of zero current. After the bandgap reference circuit module is slowly started, the bipolar transistor Bipolar2 is turned on, the grid voltages of the PMOS transistor Mp2 and the NMOS transistor Mn1 are high, and the pull-down capability of the NMOS transistor Mn1 is designed to be stronger than the pull-up capability of the PMOS transistor Mp2. Then, after the NMOS transistor Mn1 is turned on, the grid voltage of the NMOS transistor Mn2 is pulled down, and the NMOS transistor Mn2 then turns off, ceasing its operation. Thus, the startup core circuit unit no longer affects the bandgap reference circuit module, and the bandgap reference circuit module may work in a normal state due to the existence of the startup core circuit unit.

Based on FIGS. 2 and 4, the key transistor that allows the bandgap reference circuit module to have a temporary current is Mn2. Its grid is connected to an inverter output terminal composed of Mp2 and Mn1, and its drain is connected to the first output terminal of the amplifier AMP in the bandgap reference circuit module. After the NMOS transistor Mn2 is turned on, it will turn on the PMOS transistors Mp3 and Mp4 of the bandgap reference circuit module, so that the bandgap reference circuit module starts to have a temporary current.

Therefore, the startup core circuit module provided by the present disclosure may ensure that the bandgap reference circuit may escape the degenerate point operating state of zero current when the enable signal is high, and is suitable for the design of ultra-low power bandgap references. At the same time, the startup core circuit module of the present disclosure has low design difficulty and extremely low power consumption of the startup circuit, which meets the requirements of the ultra-low power design of the bandgap reference.

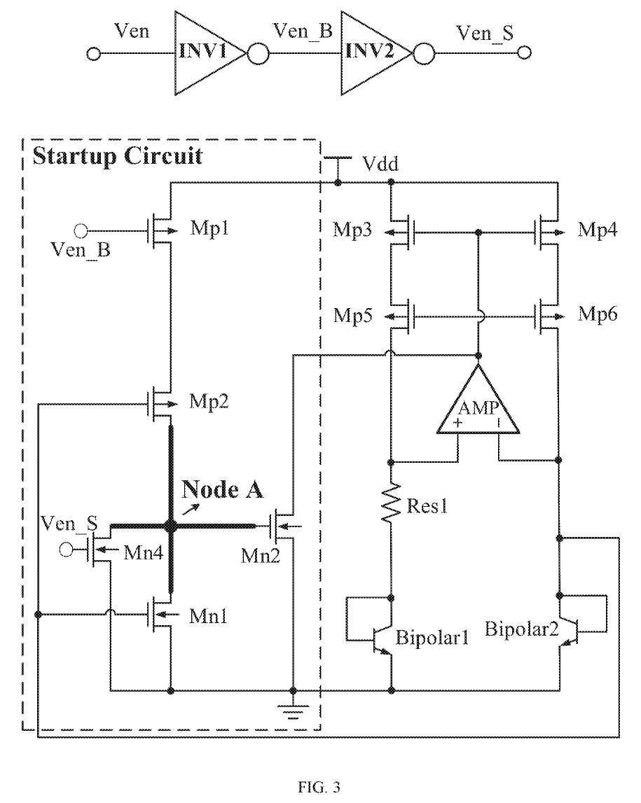

In order to further illustrate the technical effect that the bandgap reference circuit with a startup circuit for ultra-low power consumption suitable for high-temperature conditions provided by the present disclosure may maintain good operating performance even under high-temperature conditions, please refer to FIG. 3. FIG. 3 shows a diagram of the startup circuit and the ultra-low power bandgap reference circuit designed by the present disclosure without considering MOS transistor leakage.

The circuit in FIG. 3 includes a control circuit module, a startup core circuit unit, and a bandgap reference circuit module; where, the control circuit module includes an inverter INV1, an inverter INV2, a PMOS transistor Mp1, and an NMOS transistor Mn4; the startup core circuit unit is composed of a PMOS transistor Mp2, an NMOS transistor Mn1, and an NMOS transistor Mn2; and the bandgap reference circuit module is composed of a PMOS transistor Mp3, a PMOS transistor Mp4, a PMOS transistor Mp5, a PMOS transistor Mp6, a resistor Res1, a bipolar transistor Bipolar1, a bipolar transistor Bipolar2, and an amplifier AMP.

In FIG. 3, when the bandgap reference circuit module is operating normally, the grid voltage of the NMOS transistor Mn2 is a low voltage. In an ideal state, the drain current flowing through it is zero. However, due to the existence of leakage current, the NMOS transistor Mn2 draws a small amount current from the amplifier AMP. This current may be at the picoampere (PA) level, which is not negligible for the design of a bandgap reference circuit with nanoampere-(nA) level power consumption, and may affect the operating performance of the bandgap reference circuit, that is, the circuit of the amplifier AMP may have serious mismatch due to the leakage current, thereby reducing the operating gain and output precision of the bandgap reference circuit.

Based on this, the present disclosure designs a corresponding leakage compensation circuit unit to eliminate or compensate for the impact of this part of the leakage current. Please refer to the leakage compensation circuit unit in FIG. 1. The leakage compensation circuit unit includes an NMOS transistor Mn3 and a resistor Res2; a drain of the NMOS transistor Mn3 is connected to one terminal of the resistor Res2, and a source of the NMOS transistor Mn3 is grounded; the other terminal of the resistor Res2 is connected to the third terminal of the bandgap reference circuit module. The first terminal of the leakage compensation circuit unit is specifically the grid of the NMOS transistor Mn3, the grid of the NMOS transistor Mn3 is connected to the grid of Mn2, and at the same time, the transistors Mn2 and Mn3 need to adopt the same size structure during design.

Thereof, when the bandgap reference circuit module is operating and a leakage current exists in the NMOS transistor Mn2 of the startup core circuit unit, the NMOS transistor Mn3 of the leakage compensation circuit unit synchronously generates a mirrored leakage current existing in the NMOS transistor Mn2. The transistor Mn2 branch of the startup core circuit unit is connected to the branch of the output terminal of the amplifier AMP (i.e., the branch where node B is located), and the transistor Mn3 branch of the leakage compensation circuit unit is connected to the mirrored output branch of the amplifier (i.e., the branch where node C is located). Therefore, even if a leakage occurs in the transistor of the startup core circuit unit, due to the fact that the two branches of the amplifier AMP (i.e., the branches where node B and node C are located respectively) leak the same current simultaneously, the amplifier AMP remains in a balanced state without causing imbalance of the amplifier AMP, thereby ensuring the good operating performance of the ultra-low power bandgap reference circuit at high temperatures and preventing the performance of the ultra-low power bandgap reference circuit from being affected by the leakage of the MOS transistor under high-temperature conditions.

In the leakage compensation circuit unit of the present disclosure, the main function of the transistor Mn3 is to mirror the leakage current, and the function of the large resistor Res1 is to ensure that when the bandgap reference core circuit module is just started, the temporary current of the bandgap reference core circuit module is still determined by Mn2 of the startup core circuit unit. When the two paths of current pull down the voltages at both terminals of the amplifier AMP at the same time, it may cause oscillation when the circuit is just started. At this time, the large resistor Res1 may be used. When the circuit is just started, due to the existence of the large resistor of the leakage compensation circuit unit, the voltage at the first output terminal of the amplifier AMP is pulled down before the output voltage of the mirrored terminal.

The bandgap reference circuit with a startup circuit for ultra-low power consumption suitable for high-temperature conditions provided by the present disclosure has the following advantages.

The startup core circuit adopts a low-power design and has low design difficulty. The startup core circuit provides a temporary current for the bandgap reference circuit through a MOS transistor to avoid the bandgap reference circuit from falling into a deadlock state, meeting the startup requirements of the ultra-low power bandgap reference.

When there is transistor leakage in the startup core circuit unit, the leakage compensation circuit unit provides a mirrored leakage current to the bandgap reference circuit module, so that the two output branches of the amplifier of the reference bandgap circuit module leak the same current at the same time, enabling the reference bandgap circuit module to remain in a balanced operating state. Thus, the ultra-low power bandgap reference may start normally at high temperatures, and the existence of the leakage compensation circuit unit does not affect the relevant performance of the bandgap reference, allowing the bandgap reference to maintain good operating performance.

The above descriptions are only used to illustrate the technical schemes of the present disclosure, not to limit them; although the present disclosure has been described in detail with reference to the foregoing embodiments, those of ordinary skill in the art should understand that: they may still modify the technical schemes recorded in the foregoing embodiments, or equivalently replace some of the technical features; and these modifications or replacements do not make the essence of the corresponding technical schemes deviate from the spirit and scope of the technical schemes of the embodiments of the present disclosure.

What is claimed is:

1. A bandgap reference circuit with a startup circuit for ultra-low power consumption under high-temperature conditions, comprising: a control circuit module, a startup circuit module, and a bandgap reference circuit module; wherein the startup circuit module comprises a startup core circuit unit and a leakage compensation circuit unit;
the control circuit module is connected to the startup circuit module, and is configured to establish a startup identification signal of the startup core circuit unit based on an enable signal and send the startup identification signal to the startup core circuit unit;
the startup core circuit unit is connected to the bandgap reference circuit module, and is configured to provide a startup temporary current to the bandgap reference circuit module according to the startup identification signal, making the bandgap reference circuit module escape a degenerate electrical state of zero current;
the leakage compensation circuit unit is respectively connected to the startup circuit module and the bandgap reference circuit module, and is configured to generate a corresponding mirrored leakage current when the startup core circuit unit has a leakage, thereby maintaining a balanced state of the bandgap reference circuit module;
the bandgap reference circuit module is configured to generate and output a reference voltage based on an input power supply and the startup identification signal;
the startup core circuit unit comprises a positive channel metal oxide semiconductor (PMOS) transistor Mp2, a negative metal oxide semiconductor (NMOS) transistor Mn1, and an NMOS transistor Mn2;
wherein a grid of the PMOS transistor Mp2 is respectively connected to a grid of the NMOS transistor Mn1 and a first terminal of the bandgap reference circuit module, a drain of the PMOS transistor Mp2 is connected to a first terminal of the control circuit module, and a source of the PMOS transistor Mp2 is respectively connected to a second terminal of the control circuit module, a drain of the NMOS transistor Mn1, and a grid of the NMOS transistor Mn2;
the grid of the NMOS transistor Mn1 is connected to the first terminal of the bandgap reference circuit module, the drain of the NMOS transistor Mn1 is respectively connected to the grid of the NMOS transistor Mn2 and the second terminal of the control circuit module, and a source of the NMOS transistor Mn1 is grounded; and
the grid of the NMOS transistor Mn2 is respectively connected to the second terminal of the control circuit module and a first terminal of the leakage compensation circuit unit, a drain of the NMOS transistor Mn2 is connected to a second terminal of the bandgap reference circuit module, and a source of the NMOS transistor Mn2 is grounded;
the leakage compensation circuit unit comprises an NMOS transistor Mn3 and a resistor Res2;
wherein a drain of the NMOS transistor Mn3 is connected to a terminal of the resistor Res2, and a source of the NMOS transistor Mn3 is grounded; and
another terminal of the resistor Res2 is connected to a third terminal of the bandgap reference circuit module.

2. The bandgap reference circuit with the startup circuit for ultra-low power consumption under the high-temperature conditions according to claim 1, wherein the first terminal of the leakage compensation circuit unit is specifically a grid of the NMOS transistor Mn3.

3. The bandgap reference circuit with the startup circuit for ultra-low power consumption under the high-temperature conditions according to claim 1, wherein the control circuit module comprises an inverter INV1, an inverter INV2, a PMOS transistor Mp1, and an NMOS transistor Mn4;
wherein an input terminal of the inverter INV1 is connected to the enable signal, and an output terminal of the inverter INV1 is connected to an input terminal of the inverter INV2;
a grid of the PMOS transistor Mp1 is connected to the output terminal of the inverter INV1, and a drain of the PMOS transistor Mp1 is connected to the input power supply; and
a grid of the NMOS transistor Mn4 is connected to an output terminal of the inverter INV2, and a source of the NMOS transistor Mn4 is grounded.

4. The bandgap reference circuit with the startup circuit for ultra-low power consumption under the high-temperature conditions according to claim 3, wherein
the first terminal of the control circuit module is a source of the PMOS transistor Mp1, and the second terminal of the control circuit module is a drain of the NMOS transistor Mn4.

5. The bandgap reference circuit with the startup circuit for ultra-low power consumption under the high-temperature conditions according to claim 2, wherein
the bandgap reference circuit module comprises a PMOS transistor Mp3, a PMOS transistor Mp4, a PMOS transistor Mp5, a PMOS transistor Mp6, a resistor Res1, a bipolar transistor Bipolar1, a bipolar transistor Bipolar2, and an amplifier AMP;
wherein a grid of the PMOS transistor Mp3 is respectively connected to a grid of the PMOS transistor Mp4 and a first output terminal of the amplifier AMP, a drain of the PMOS transistor Mp3 is connected to the input power supply, and a source of the PMOS transistor Mp3 is connected to a drain of the PMOS transistor Mp5;
the grid of the PMOS transistor Mp4 is connected to the first output terminal of the amplifier AMP, a drain of the PMOS transistor Mp4 is connected to the input power supply, and a source of the PMOS transistor Mp4 is connected to a drain of the PMOS transistor Mp6;
a grid of the PMOS transistor Mp5 is connected to a grid of the PMOS transistor Mp6, and a source of the PMOS transistor Mp5 is respectively connected to a non-inverting input terminal of the amplifier AMP and one terminal of the resistor Res1;
a source of the PMOS transistor Mp6 is respectively connected to an inverting input terminal of the amplifier AMP, a base of the bipolar transistor Bipolar2, and a collector of the bipolar transistor Bipolar2;
the terminal of the resistor Res1 is connected to the non-inverting input terminal of the amplifier AMP, and another terminal of the resistor Res1 is respectively connected to a base of the bipolar transistor Bipolar1 and a collector of the bipolar transistor Bipolar1;
an emitter of the bipolar transistor Bipolar1 is grounded; and
the base of the bipolar transistor Bipolar2 is respectively connected to the collector of the bipolar transistor Bipolar2 and the inverting input terminal of the amplifier AMP, and an emitter of the bipolar transistor Bipolar2 is grounded.

6. The bandgap reference circuit with the startup circuit for ultra-low power consumption under the high-temperature conditions according to claim 5, wherein the first terminal of the bandgap reference circuit module is the inverting input terminal of the amplifier AMP, the second terminal of the bandgap reference circuit module is the first output terminal of the amplifier AMP, and the third terminal of the bandgap reference circuit module is a second output terminal of the amplifier AMP.

7. The bandgap reference circuit with the startup circuit for ultra-low power consumption under the high-temperature conditions according to claim 6, wherein the amplifier AMP comprises an NMOS transistor Man1, an NMOS transistor Man2, an NMOS transistor Man3, an NMOS transistor Man4, an NMOS transistor Man5, an NMOS transistor Man6, an NMOS transistor Man7, a PMOS transistor Map1, a PMOS transistor Map2, a PMOS transistor Map3, a PMOS transistor Map4, and a PMOS transistor Map5;
wherein the NMOS transistor Man1 and the NMOS transistor Man2 form an input pair transistor of the amplifier AMP, the PMOS transistor Map1 and the PMOS transistor Map2 form a current mirror load of the amplifier AMP, and the NMOS transistor Man4 and the PMOS transistor Map5 form a current mirror load mirrored current branch of the amplifier AMP.

8. The bandgap reference circuit with the startup circuit for ultra-low power consumption under the high-temperature conditions according to claim 7, wherein the first output terminal of the amplifier AMP is an output terminal of the current mirror load mirrored current branch; and the second output terminal of the amplifier AMP is an output terminal of the current mirror load.
